(19) United States
(12) Patent Application Publication
(10) Pub. No.: US 2006/0102240 A1
(43) Pub. Date: May 18, 2006

(54) Sealing elements for compressor valves

(76) Inventors: Bernhard Spiegl, Wien (AT); Dietmar Artner, Oberwart (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/273,273

(22) Filed: Nov. 14, 2005

Related U.S. Application Data
(63) Continuation-in-part of application No. 10/288,465, filed on Nov. 6, 2002, now abandoned.

(30) Foreign Application Priority Data
Nov. 7, 2001 (AT) A 1753/2001

(51) Int. Cl. F16K 15/16

(52) U.S. Cl. 137/855; 251/368

(57) ABSTRACT

In sealing elements (3, 3′, 3″) made of synthetic material (14) having embedded fiber reinforcement (11), as it has been used for some time for automatic compressor valves, the fiber reinforcement (11) consists of at least one piece of an essentially flat, non-woven fiber fabric (12), which has, at least in its plane, a directionally independent (random) fiber orientation. Disadvantages of short-fibered reinforced synthetic materials can thereby be avoided, as well as the ones for synthetic materials reinforced by means of long-fibered fabrics, and sealing elements (3, 3′, 3″) may be obtained thereby having a very high durability.

This application is a continuation-in-part of application Ser. No. 10/288,465, filed Nov. 6, 2002.

### BACKGROUND OF THE INVENTION

1. Field of the Invention

The invention relates to sealing elements, particularly sealing plates, sealing rings, and sealing lamellas for automatic compressor valves composed of synthetic material with embedded fiber reinforcement.

2. The Prior Art

Fiber-reinforced synthetic materials have been employed for years as material for sealing elements of the aforementioned type. See in this respect, for example, EP 40 930 A1, EP 933 566 A1 or U.S. Pat. No. 3,536,094.

Basically, a distinction can be made between two different types of fiber reinforcements: on one hand, so-called short-fibered reinforced synthetic materials are used, and on the other hand, so-called long-fibered reinforced materials are used. Short-fibered reinforced synthetic materials are mainly used in the injection molding method and they have a very short fiber length of approximately 0.1 to 0.3 mm based on this type of fabrication. Even with the use of special granules having considerably longer initial fiber lengths of up to 20 mm, unavoidable breaks in fiber during fabrication by injection molding do not lead to a significant increase in fibers with a mid-size length in the manufactured sealing elements. Through the short fiber length, the contribution Qf fibers for an increase in stability and rigidity is relatively small whereby the reinforcement effect of these short fibers is decreased even more at high operational temperatures. The ends of each fiber are a potential source for defects in the surrounding synthetic material since cracks may develop or be enhanced thereby. To be able to achieve a useful rigidity of the manufactured sealing element, a large proportion of fiber volume must be realized, which then again reduces the desired damping behavior of the element and which also contributes to the breakdown of fiber length during fabrication. In addition, there occurs a specific layer distribution in short-fiber reinforced thermoplastics, which is flow-conditional in injection molding fabrication and which is made responsible for high residual stress and warping problems in the finished element.

The otherwise used long-fiber products contain mostly fiber reinforcements in the form of bundles (in the amount of 500 to 50,000 practically endless fibers, so-called rovings), which are used in the form of inter-woven structures for reinforcement of thermoplastic or duroplastic synthetic materials. Moreover, layers with uniformly oriented long fibers are used as well, so-called unidirectional layers. These products are distinguished by their very high degree of rigidity and stability in the direction of the fibers, whereby a greater proportion of fiber volume can be realized based on a larger fiber packing in the woven material. However, long-fibered reinforced synthetic material of this type cannot be used in the injection molding method. For manufacturing of valve plate blanks or semi-finished plates—from which sealing plates, sealing rings, and sealing lamellas are mechanically fabricated—compression molding methods are used whereby mostly pre-impregnated woven mats made of rovings (so-called prepregs) are compression molded under pressure and high temperatures. The problem with such long-fibered reinforced material is the fact that the roving bundles can hardly be impregnated, especially the ones made of high-viscosity thermoplastics, and the very dense fiber bundles produce interfaces at their surfaces which tend to experience delamination at impact, normally to the surface.

Because of the above-described reasons, short-fibered as well as long-fibered reinforced synthetic material for sealing elements of the aforementioned type have found considerably wider application in conjunction with the rather low-stressed ring valves or plate valves.

It is the object of the present invention to avoid the described disadvantages of the known sealing elements of the aforementioned type and to improve such sealing elements so that the durability of the sealing elements is significantly increased even under the unfavorable, highly dynamic stresses occurring during operation in automatic compressor valves.

### SUMMARY OF THE INVENTION

This object is achieved according to the invention for sealing elements of the aforementioned type in that the fiber reinforcement is composed of at least one piece of an essentially flat, non-woven fiber fabric, which has, at least in its plane, a directionally independent (random) fiber orientation, in general. Such non-woven fiber fabrics (called aptly non-woven fiber fabrics in the English language) are made of individual fibers, preferably having a length of at least more than 2 mm for the most part, especially preferred at least more than 4 mm for the most part, and include no binding agents, bonding agents, agglutinants or cements (either they contain no such agents when made or such agents are removed by heating prior to soaking with synthetic material of the invention). The individual fibers are randomly oriented in a plane and have possibly a minor preferred orientation associated with the manufacturing process. Sealing elements, blanks, and semi-finished plates can be manufactured in a compression molding process thereby and there are generally no limitations relative to the fiber length. The development of residual stress and events of warping are eliminated by the possible symmetrical and uniform structure. The great fiber length of the individual fibers creates a high reinforcement effect whereby the required rigidity can be realized with a small proportion of fibers. The average proportion of fiber volume lies in the finished sealing element in the range of 5 to 30 percent in an especially preferred embodiment of the invention, preferably in the range of 10 to 20 percent. The favorable damping characteristics of the composite are barely influenced in the direction of the depth of the body. The low modulus in the direction of the depth of the body enhances, at the same time, high density and rapid forming of density in the application.

The even distribution of individual fibers in the non-woven fiber fabrics prevents delamination at the interfaces and makes very simple impregnation possible, for example, even in case of a polymeric molten mass of very high viscosity.

In an additional preferred embodiment of the invention, the fiber fabric consists of glass fibers, aramide fibers, steel fibers, ceramic fibers, carbon fibers, or a mixture thereof, but preferably of carbon fiber—and the surrounding synthetic material consists of duroplastic or thermoplastic synthetic material, particularly epoxy resin, bis-maleimide resin, polyurethane resin, silicone resin, PEEK, PA, PPA, PTFE, PFA, PPS, PBT, PET, PI or PAI, preferably PEEK, PA, PFA or PPS. Basically, all fiber material mentioned as examples, and all synthetic material mentioned as examples, may be used in concert at the simplest manufacturing conditions since existing differences in adhesive behavior of the individual materials to one another cannot have a negative influence on the overall composite based on the great fiber length. While individual combinations of fiber material and synthetic material are not suitable for injection molding fabrication with short-fiber reinforcement based on poor mutual adhesion, for example, there are no problems to be expected in this respect with the fiber lengths used therein.

Fabrication may be performed by continuous compression molding in a double-belt press or by intermittent compression molding using individual compression molds. In case of thermoplastic molds, the molten mass or powder is applied to the pieces of fabric and subsequently both parts are pressed together by compression molding—or corresponding plastic sheets of a thickness in the range of 0.02 mm to 2 mm are layered together with the non-woven fiber fabric and pressed together under pressure at high temperatures. In duroplastic resin systems, resin may be applied to the fiber fabric and then hardened under high temperature and pressure.

In an especially preferred additional embodiment of the invention, the fiber fabric reinforcement and/or the surrounding synthetic material in the finished sealing element has an inhomogeneous distribution and/or has locally different material characteristics under consideration of different local requirements. Thus, there can be met the special requirements for respective sealing elements in various ways in view of rigidity, damping or impact resistance as well as in view of various other requirements. The inhomogeneous characteristics relative to distribution and/or the different material characteristics may vary throughout the cross section of the sealing element as well as in its radial direction, for example. Various influences can thereby be exerted relative to the special local characteristics of the sealing element.

In a preferred embodiment of the invention, the inhomogeneous distribution is dependent on the size and/or shape and/or the material and/or the spatial arrangement or distribution of one or more pieces of fiber fabric, which make the above-mentioned influences possible for the material characteristics of the sealing elements.

According to another advantageous embodiment of the invention, the near-surface region of the finished sealing element, which faces the seat surface and/or the surface of the stop element, is free of fiber reinforcement preferably up to a depth that is at least two-times or three-times the size of the fiber diameter. In automatic compressor valves, and in conjunction with the use of the sealing elements, the development of cracks after near-surface fiber breaks in the proximity of the seat shoulder edge can be avoided and the tribological behavior of the sealing elements can be improved.

In an additional preferred embodiment of the invention, the fiber-free regions near the surface consist of different material compared to the rest of the sealing element, preferably having a better toughness and/or high damping characteristics and/or higher resistance against cracking caused by fatigue. The thereby created functional top layers serve to reduce spikes in stress at the immediate seat area through additional damping of impact whereby the development of cracks is prevented in these regions. A microscopic examination of the sealing elements, which are designed without such functional top layers, show often times that the fibers disposed on the surface—or just below the surface—do not bend at impact according to the strong deformations in the area of seat shoulders, and they subsequently break, whereby the expansion and joining of microscopic cracks leads to the formation of macroscopic cracks, which leads in turn to malfunctioning of the sealing element. In addition, adhesion of dirt particles or the like is prevented by the fiber-free functional top layer.

Since traditional mechanical fabrication of the shaped and finished sealing element can be difficult under circumstances by cutting it from a semi-finished plate having a fiber-free top layer, especially with its design of being made with materials of great toughness, cutting with a water jet (water torch) under high pressure has been shown to be especially advantageous, particularly in this application.

In a further preferred embodiment of the invention, an intermediate layer, which is disposed between the seat surface and the surface of the stop element, is provided with less fiber reinforcement relative to the neighboring layers, preferably a decreased proportion of fiber volume compared to the neighboring regions. The characteristic profile of the material or the finished sealing element can thereby be adapted to the respective requirements as well. Rigidity characteristics and damping characteristics can be optimized by varying the proportion of fiber volume throughout the depth of the element, which may be easily achieved by a change in structure during the compression molding process.

In the following, the invention is described in more detail with the aid of partially schematic drawings.

### BRIEF DESCRIPTION OF THE DRAWINGS

FIG. 1 shows thereby a perspective view of a partial cutaway view of the compressor valve having a sealing plate designed according to the invention;

FIG. 2 shows a partial cross section through a lamellar valve used as a pressure valve of a compressor (not further illustrated) having a sealing lamella designed according to the invention;

FIG. 3 shows a top view onto the sealing lamella according to FIG. 2;

FIG. 4 shows a perspective view of a partial cutaway view of a compressor valve having individual sealing rings according to the present invention;

FIG. 5 shows a schematic illustration of a section of a non-woven fiber fabric for use as fiber reinforcement in a sealing element according to FIGS. 1-4, for example;

FIG. 6 shows the enlarged detail VI from FIG. 5;

FIG. 7 shows a schematic fabrication device for intermittent compression molding having a single compression mold to manufacture a semi-finished plate for a sealing element according to the invention;

FIGS. 8 and 9 show, for example, fabrication devices to manufacture semi-finished strips for sealing elements of the invention by continuous compression molding in double-belt presses;

FIG. 10 shows a magnification of the cross section X in FIG. 1; and

FIG. 11 shows a diagram symbolizing the local or layer-wise varying fiber reinforcement in a cross section according to FIG. 10.

### DETAILED DESCRIPTION OF THE PREFERRED EMBODIMENTS

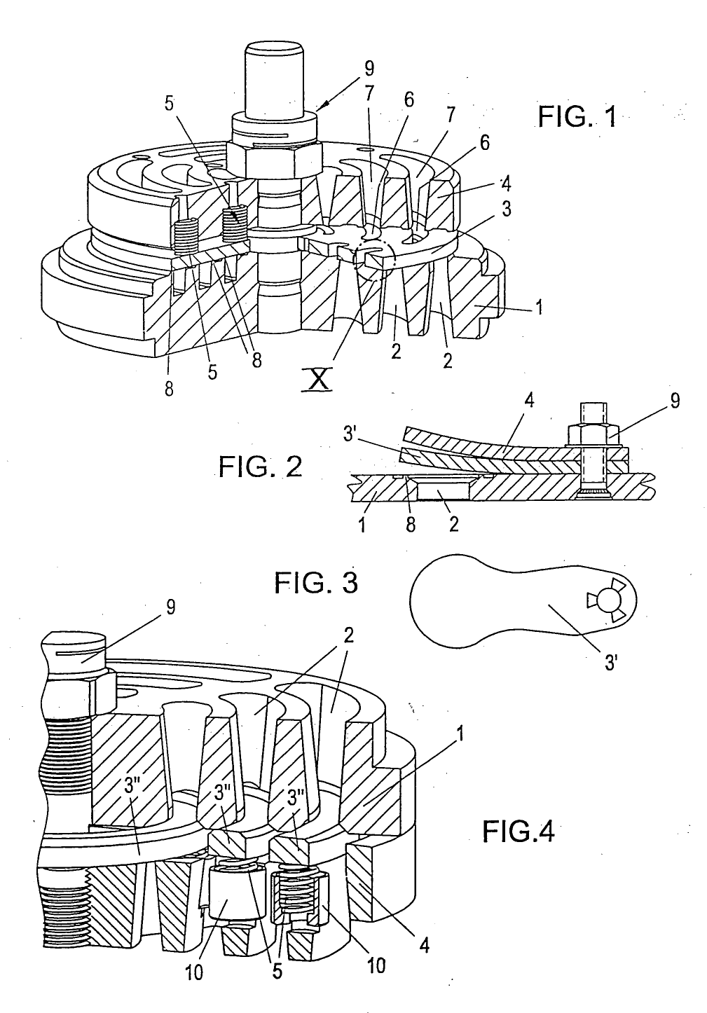

The automatic compressor valve in FIG. 1 consists essentially of a valve seat 1 whose essentially annular, concentrically arranged passage ports 2 are covered by a sealing plate 3, which is urged in the directed of the valve seat 1 from the start element 4 by means of a coil spring 5. A center bolt 9 holds the components together; the surrounding area for installation is not illustrated. After surpassing a pressure difference, which may be determined by the spring 5, the sealing plate 3 opens the passage port 2 by lifting from the valve seat 1 whereby the pressure medium can now flow through the concentric slots 6 in the sealing plate 3 and the corresponding exhaust ports 7 in the stop element 4.

Lifting of the seal plate 3 from the valve seat 1 or the sealing shoulders 8 formed thereon—stopping at the stop element 4 at the opposite side, after surpassing the reciprocation gap predetermined by the design of the valve—and recurring stopping of the sealing plate 3 at the valve seat 1 or the valve shoulders 8 at the end phase of the valve opening—all this occurs automatically depending on the stroke movement of the compressor piston (not illustrated) and the thereby corresponding dynamic to highly dynamic medium flow. This medium flow determines in turn the dynamic stress on the sealing plate 3 for which there are special requirements in its construction and selection of material in view of a sufficiently high durability of all participating components.

The valve seat 1 in the lamellar valve of FIG. 2 is provided with only one circular passage port 2 whose sealing shoulder 8 cooperates with a sealing lamella 3′, which extends essentially in longitudinal direction, and which held to the valve seat 1 and the stopping element 4 by means of a bolt 9 whereby the stopping element 4 also extends in longitudinal direction. The sealing lamella 3′ is here not separately biased by a spring and it tightly rests against the valve seat in the closed condition of the valve by being possibly pre-stressed internally. In FIG. 2 there is illustrated the sealing lamella 3′ in an already raised intermediate position before it comes to rest completely against the stop element 4 at the end of its possible lifting motion. Apart from the illustrated design of having a single passage port 2 assigned to the sealing lamella 3, there could also be covered or controlled a plurality of neighboring passage ports of this type by one common sealing lamella 3′. Dynamic movement and stress develops here also on the sealing lamella 3′, especially at its free end facing the passage port 2, which is caused by the dynamic to highly dynamic reciprocating movement of the compressor piston (not further illustrated). In addition, there also develops a dynamic bending stress in the region between the bolt 9 and the free end of the sealing lamella 3′, which results in a total stress for the sealing element that deviates somewhat from the one in FIG. 1.

The compressor valve in FIG. 4 is in some way again similar to the one in FIG. 1 whereby a valve seat 1 is provided with concentric passage ports 2 and whereby a corresponding stop element 4 are also held together by means of a center bolt 9. In place of the one-piece sealing plate 3, there are provided individual concentric sealing rings 3″, which are separately biased by means of springs 5 arranged in sleeves 10 and extending from the stop element 4 whereby said sealing rings 3″ may move independently from one another between the valve seat 1 and the stop element 4. The movement and stress on the sealing rings 3″ occurs dynamically and they are again dependent on the periodic movement of the piston in the compressor (not further illustrated) or the pressure cycles caused thereby, which again results in stress characteristics, based on the individual sealing rings 3″, and which also deviates from the situation in the valve according to FIG. 1.

All application examples of the inventive sealing element illustrated in FIGS. 1-4 have as a common feature the dynamic to highly dynamic stress caused by surface impact while sealing shoulders or stop elements are being struck, which leads in all cases to similar advantageous solutions for problems to be considered in view of the structural design and selection of materials for major sealing elements made of synthetic material with embedded fiber reinforcement.

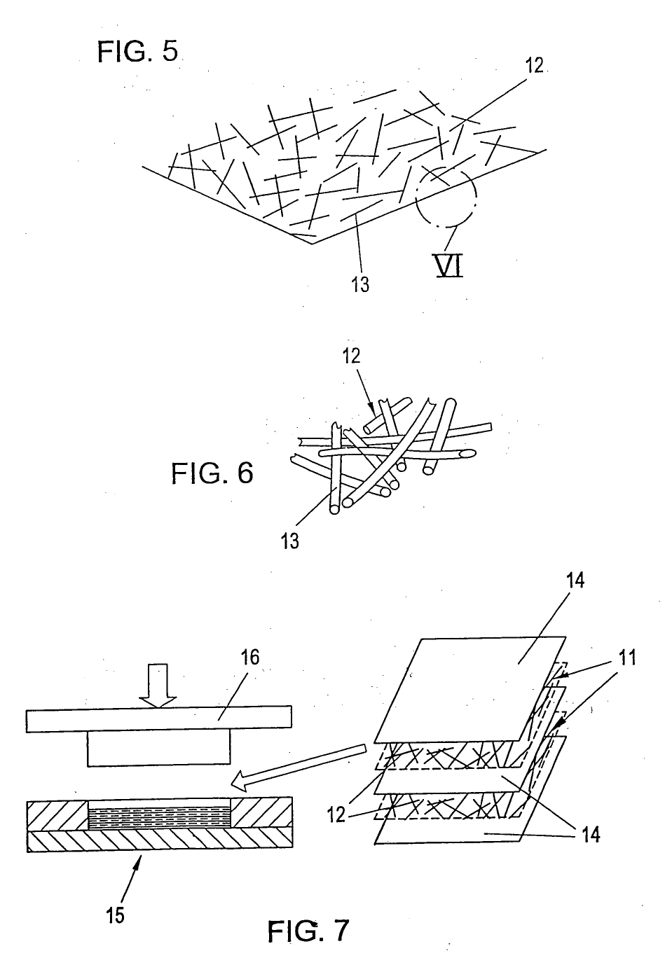

According to the invention, the fiber reinforcement 11 in FIGS. 5-11 consists of at least one essentially flat non-woven fiber fabric 12 having in the plane a random fiber orientation (see in this matter especially FIG. 5 and FIG. 6). Through the thereby possible symmetric and uniform structure there is prevented the development of residual stress and warping in the sealing elements. Based on the great fiber length of preferably more than 2 mm, for the most part, there is provided a high reinforcement effect through which the required rigidity of the sealing elements may be realized already with a low proportion of fibers (the preferred average proportion in fiber volume in the finished sealing element is in the range of 5 to 30 percent). This results furthermore in favorable damping characteristics of the sealing element in the direction of depth of the body, and a high density as well by reaching a higher density more rapidly in the application. The even or directionally independent (random) distribution of individual fibers 13 within the non-woven fiber fabric 12 prevents delamination of the interfaces and makes very simple impregnation possible, even in case of polymeric molten masses of very high viscosity.

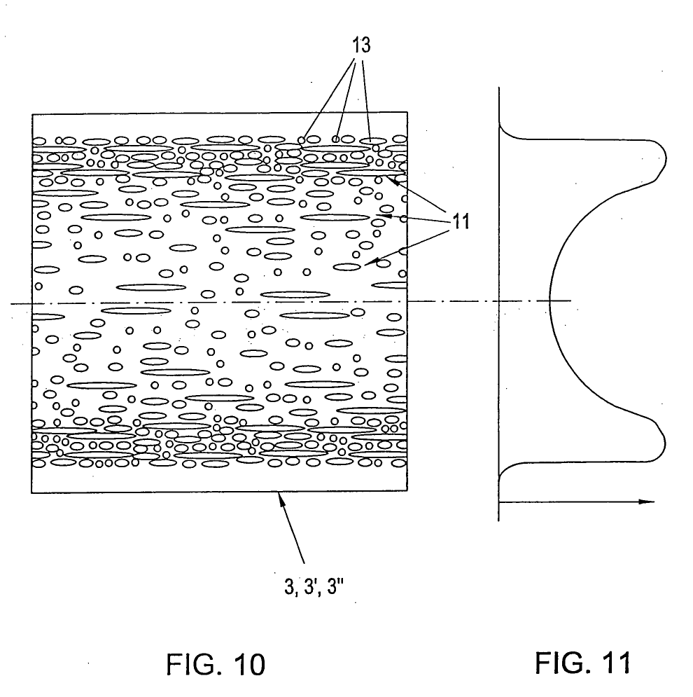

FIG. 7 illustrates in a symbolic manner the manufacturing of a semi-finished plate from which there can be cut out sealing elements for the use in applications according to FIGS. 1-4 by cutting with a water jet (water torch), which guarantees an excellent fabrication quality even with [synthetic] materials having a relatively highly elastic or tough surface layers. Layers of plastic sheets 14 and non-woven fiber fabrics 12 which contain no binder, bonding agent, agglutinant or cement are alternately placed on top of one another and then compressed in a compression mold 15 under heat by means of a compression molding plug 16. Through the number, thickness, sequence, selection of material, or the like, of the layer, the characteristics of the pre-finished plates can be predetermined and the finished sealing element obtains qualities that can be adjusted to the respective case of application. A structure according to FIGS. 10-11 can be achieved, for example, through thicker, fiber-free top layers and through decreased proportion in fiber volume in the center compared to the remaining cross section of the sealing element, whereby said structure ensures, on one hand, an excellent damping quality of the sealing element while having sufficient rigidity, and it ensures, on the other hand, that no near-surface fiber breaks occur (with subsequent expansions of cracks) caused by the compressive impact stress on the surface.

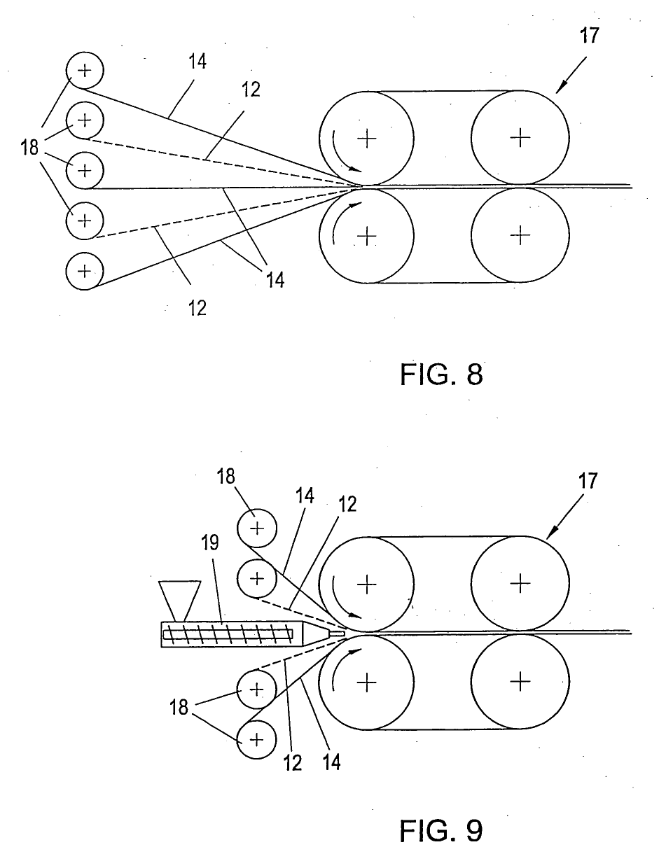

According to FIG. 8, fabrication of essentially strip-shaped semi-finished materials may be performed by continuous compression molding in a double-belt press 17 whereby a plastic sheet 14 and a piece of fiber fabric 12 is alternately fed from the feed rollers 18 into the double-belt press in which area they are then thermally compression molded.

According to FIG. 9, and deviating from FIG. 8, molten mass or powder may be inserted between the pieces of fiber fabric 12 by means of a feeding device 19 in case of a thermoplastic mold whereby all parts are subsequently compression molded together in the double-belt press 17. The same applies to duroplastic resin systems in which resin is applied via a feeding device 19 onto the fiber fabric 13 and then left there to harden under high temperature and pressure.

We claim:

1. A durable sealing element for an automatic compressor valve, said sealing element being composed of synthetic material with embedded fiber reinforcement, wherein said fiber reinforcement is composed of at least one piece of an essentially flat, non-woven fiber fabric, which has, at least in its plane, a directionally independent, generally random, fiber orientation, and which contains no binding or bonding agent.

2. A sealing element according to claim 1, wherein individual fibers in said fiber fabric generally have a length of at least 2 mm.

3. A sealing element according to claim 2, wherein said length is more than 4 mm.

4. A sealing element according to claim 1, wherein the average proportion of fiber volume in the sealing element is in the range of 5 to 30 percent.

5. A sealing element according to claim 4, wherein said average proportion is 10 to 20 percent.

6. A sealing element according to claim 1, wherein said fiber fabric is selected from the group consisting of glass fibers, aramide fibers, steel fibers, ceramic fibers, carbon fibers, or a mixture thereof, and said surrounding synthetic material consists of duroplastic or thermoplastic synthetic material selected from the group consisting of epoxy resin, bis-maleimide resin, polyurethane resin, silicone resin, PEEK, PA, PPA, PTFE, PFA, PPS, PBT, PET, PI and PAI.

7. A sealing element according to claim 1, wherein at least one of said fiber fabric reinforcement and said synthetic material in the sealing element has an inhomogeneous distribution and/or has locally different material characteristics under consideration of different local requirements.

8. A sealing element according to claim 7, wherein the inhomogeneous distribution is dependent on at least one of size, shape, material and the spatial arrangement or distribution of at least one piece of said fiber fabric.

9. A sealing element according to claim 7, wherein a near-surface region of said finished sealing element, which faces at least one of a seat surface and a surface of a stop element of the compressor valve is free of fiber reinforcement up to a depth that is at least two times the size of the fiber diameter.

10. A sealing element according to claim 9, wherein the fiber-free regions near the surface consist of different material compared to the rest of said sealing element.

11. A sealing element according to claim 10, wherein said different material has at least one of improved toughness, higher damping characteristics, and higher resistance against cracking caused by fatigue.

12. A sealing element according to claim 7, including an intermediate layer disposed between the seat surface and the surface of the stop element, said intermediate layer having less fiber reinforcement relative to the neighboring layers.

13. A sealing element according to claim 12, wherein said intermediate layer has a reduced proportion of fiber volume compared to neighboring regions.

14. A sealing element according to claim 1, wherein a said non-woven fiber fabric is compression molded between outer layers of said synthetic material.
